(19) United States
(12) Patent Application Publication
(10) Pub. No.: US 2011/0106610 A1
(43) Pub. Date: May 5, 2011

(54) Systems and methods for providing and commercially exploiting online persona validation

(76) Inventors: Kenneth M. Landis, Tampa, FL (US); Jennifer Steinmann, San Francisco, CA (US); Arun Kumar Prasad, Pleasantville, NY (US); Caroline Buchanan Hribar, New York, NY (US)

(21) Appl. No.: 12/924,885

(22) Filed: Oct. 6, 2010

Related U.S. Application Data
(60) Provisional application No. 61/278,479, filed on Oct. 6, 2009.

(51) Int. Cl. G06Q 30/00

(52) U.S. Cl. 705/14.39; 705/14.53; 705/14.58; 705/14.52; 705/14.66; 705/14.73

(57) ABSTRACT

Systems and methods for providing and commercially exploiting online persona validation are presented. In exemplary embodiments of the present invention, an online persona validation framework suitable for mass adoption is presented. In addition, systems and methods to leverage such framework to create and exploit transactional opportunities, such as, for example, targeted marketing, trend spotting and tracking, and granular data mining, are also presented. In exemplary embodiments of the present invention, tiered (i.e., comprising various levels of financial, demographic, lifestyle and other information), opt-in identity validation systems and various methods that authenticate an individual in e-commerce, social networks, job searches and the like, can be implemented. In addition, such exemplary systems and methods can identify precise, granular, and hence, valuable, demographics for advertisers. In comparison to conventional Internet based services, exemplary systems according to the present invention can provide multi-use Internet-wide trusted persona validation, micro-segment targeted ads and offers, and real time, location based, channel integrated ads and offers. The present invention accordingly comprises the various steps and the relation of one or more of such steps with respect to each of the others, and the system embodies features of construction, combinations of elements and arrangement of parts that are adapted to effect and implement such steps.

### CROSS-REFERENCE TO RELATED APPLICATIONS

This patent application claims the benefit of U.S. Provisional Patent Application No. 61/278,479, filed on Oct. 6, 2009, which is hereby incorporated herein in its entirety.

### COPYRIGHT NOTICE

Portions of the following patent disclosure contain materials that are subject to copyright protection. The copyright owner has no objection to the facsimile reproduction of the patent document or patent disclosure as it appears in the U.S. Patent and Trademark Office patent files or records solely for use in connection with consideration of the prosecution of this patent application, but otherwise reserves all copyright rights whatsoever.

### TECHNICAL FIELD

The present invention generally relates to e-commerce and Internet based interactions. In particular, the present invention presents a novel system and method for providing online persona validation. The present invention also presents various systems and methods to leverage data obtained in such persona validation to create and exploit a variety of data warehousing and data mining, commercial opportunities and markets.

### BACKGROUND OF THE INVENTION

The evolution of the Internet in general, and the World Wide Web in particular, continue to shape how people and businesses interact. Online social and professional networking websites, in particular, have created new opportunities, a variety of new contexts for interaction and channels for commerce. FIG. 1, for example, illustrates the growth in the United States of online networking, and the various resulting commercial transactions, both on and off-line, in various segments.

The growth of online networking and interactions has, however, increased the complexity of, as well as the challenges associated with, fraud and persona validation, and has thus raised many concerns regarding engaging in transactions and interactions over the Internet. For example, website users want to be assured that the online and real world personas of the persons they are dealing or interacting with match. Similarly, prospective employers want to be able to rely upon representations regarding work experience and educational credentials provided by prospective employees via Internet based employment applications and the like. The inability to verify an online persona leaves participants vulnerable to online and real world crime, especially when online relationships go commercial. Such inability can also wreak havoc on a social life, and dash hope and aspirations when one is not corresponding or communicating with who they imagine they are. FIG. 2 illustrates the pressing need for persona validation in view of the growth in online and online-initiated crime, fraud and impersonation and misrepresentation. With reference thereto, FIG. 2 depicts the various consumer segment needs for each of Professional/Career Networking, Online Dating, Social Networking and Online Classifieds types of interactions. FIG. 2 also depicts statistics and various egregious examples all illustrating the fraud and misrepresentation that these online interactions are permeated with. What is clearly needed in the art are systems and methods to address these problems, and allow participants in various online interactions to have assurances that (i) the people they interact with are who they say they are, and (ii) that the information those people present and disseminate in such interactions is accurate.

### BRIEF DESCRIPTION OF THE DRAWINGS

For a fuller understanding of the invention, reference is made to the following description, taken in connection with the accompanying drawings, in which:

FIG. 1 is a chart illustrating the growth in the United States of online networking, and the resulting related commerce, across various customer segments;

FIG. 2 is a chart illustrating the need for persona validation in view of the growth and prevalence of online and online-initiated crime;

FIG. 3 is a chart illustrating how persona validation can benefit both individual consumers and merchants in a variety of interactive contexts;

FIGS. 4A and 4B are high-level flowcharts depicting process steps for implementing an exemplary tiered identity persona validation system and method according to an exemplary embodiment of the present invention;

FIG. 5 is a schematic diagram illustrating persona validation provided as an add-on product associated with a credit card, bank card or the like in accordance with an advantageous exemplary embodiment of the present invention;

FIG. 6 is a high-level flowchart depicting process steps for implementing a persona validation system and method that leverages mobile technology according to an alternative exemplary embodiment of the present invention;

FIG. 7 illustrates how exemplary embodiments of the present invention can serve as a hub for persona validation, online advertising and direct marketing;

FIG. 8 illustrates various consumer interactions according to an exemplary embodiment of the present invention;

FIG. 9-12 illustrate an exemplary single user experience for an exemplary individual system user according to an exemplary embodiment of the present invention;

FIGS. 9-10 illustrates account setup, initial authentication and personal attribute verification, as well as setting of profile preferences for the exemplary fictional user “Kate C” according to an exemplary embodiment of the present invention;

FIGS. 11-12 illustrate providing high-value targeted offers to a user, based on such user's on-line and off-line habits according to an exemplary embodiment of the present invention;

FIG. 13 depicts exemplary back-end technologies used to support a seamless and anonymous experience in an exemplary system according to exemplary embodiments of the present invention;

FIG. 14 illustrates using three inter-related components enabling communications between customers/users, merchants and advertising/marketing partners according to an exemplary embodiment of the present invention;

FIGS. 15-16 depict an exemplary technology architecture with various modules and sub-modules according to an exemplary embodiment of the present invention;

FIG. 17 depicts detail of the Data Services module of FIG. 15; and

FIGS. 18-23 depict exemplary service provider process flows for operation and administration according to an exemplary embodiment of the present invention.

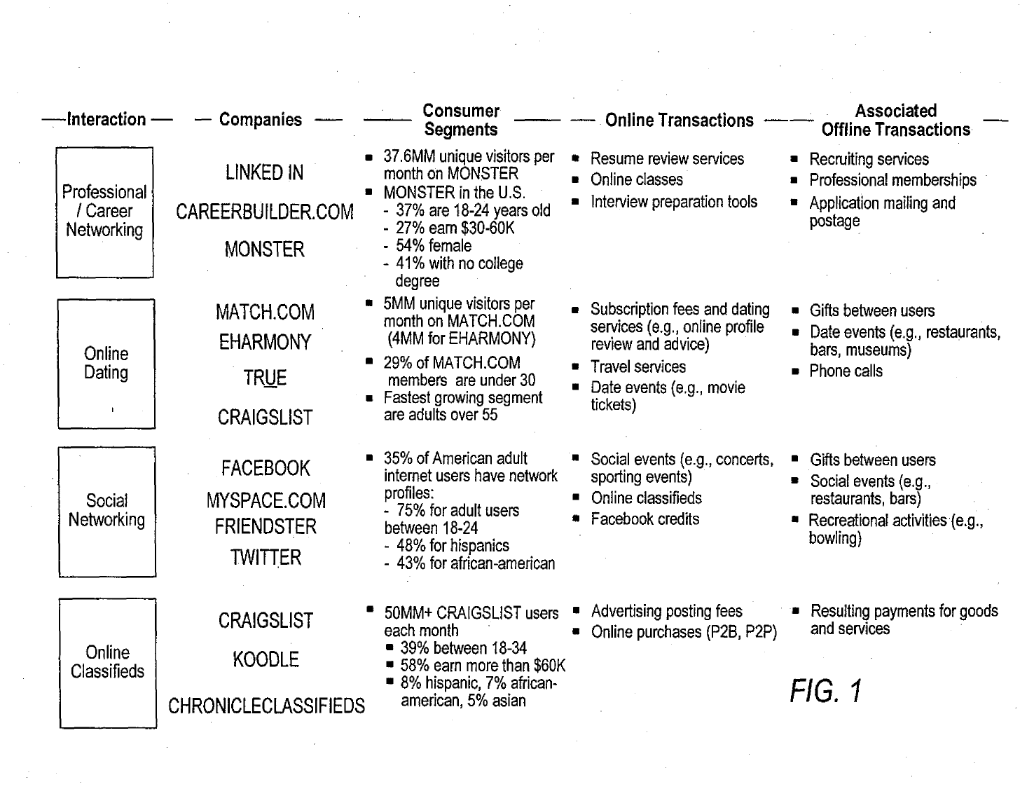

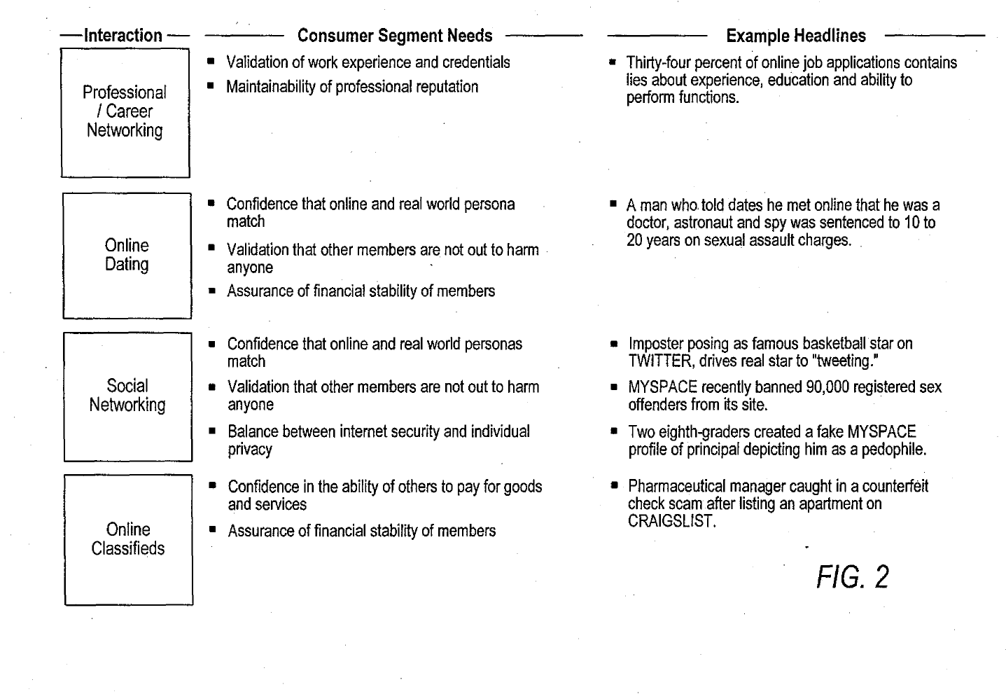

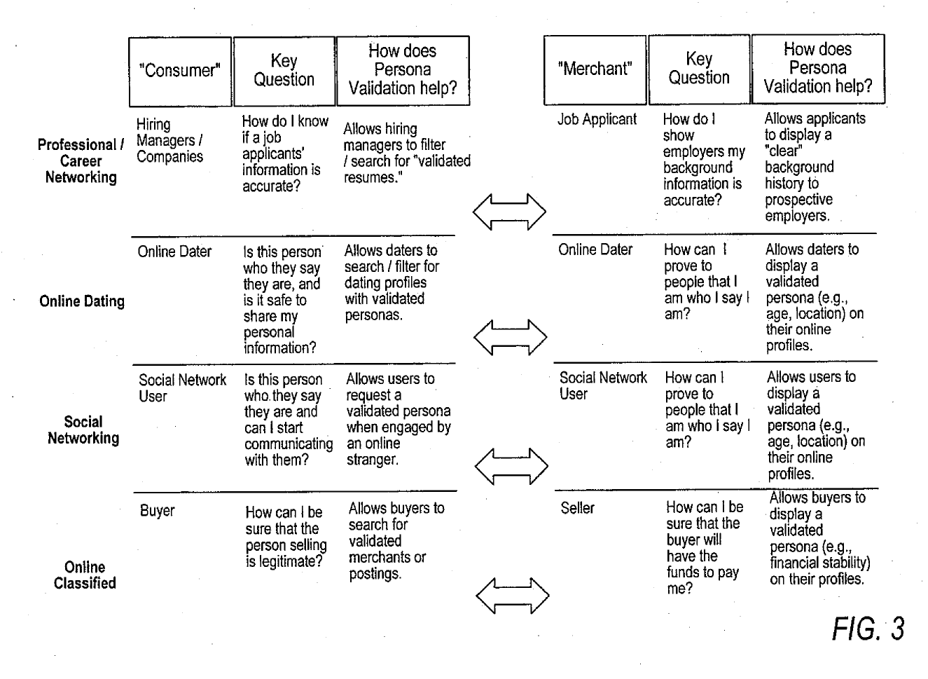

It is noted that in the accompanying drawings as well as in the following description, an exemplary system named “Victor” is used to refer to various embodiments of the present invention. This is an internal name the inventors have associated with such an exemplary embodiment, for convenience.

It is further noted that the patent or application file contains at least one drawing executed in color. Copies of this patent or patent application publication with color drawings will be provided by the U.S. Patent Office upon request and payment of the necessary fees.

### SUMMARY OF THE INVENTION

Systems and methods for providing and commercially exploiting online persona validation are presented. In exemplary embodiments of the present invention, an online persona validation framework suitable for mass adoption is presented. In addition, systems and methods to leverage such framework to create and exploit transactional opportunities, such as, for example, targeted marketing, trend spotting and tracking, and granular data mining, are also presented. In exemplary embodiments of the present invention, tiered (i.e., comprising various levels of financial, demographic, lifestyle and other information), opt-in identity validation systems and various methods that authenticate an individual in e-commerce, social networks, job searches and the like, can be implemented. In addition, such exemplary systems and methods can identify precise, granular, and hence, valuable, demographics for advertisers. The present invention accordingly comprises the various steps and the relation of one or more of such steps with respect to each of the others, and the system embodies features of construction, combinations of elements and arrangement of parts that are adapted to effect and implement such steps, all as exemplified in the following detailed disclosure and accompanying drawings. In comparison to conventional Internet based services, exemplary systems according to the present invention can provide multi-use Internet-wide trusted persona validation, micro-segment targeted ads and offers, and real time, location based, channel integrated ads and offers. The foregoing and other objects, aspects, features and advantages of the invention will in part be obvious and will in part be apparent from this disclosure and the accompanying drawing figures.

### DETAILED DESCRIPTION OF THE INVENTION

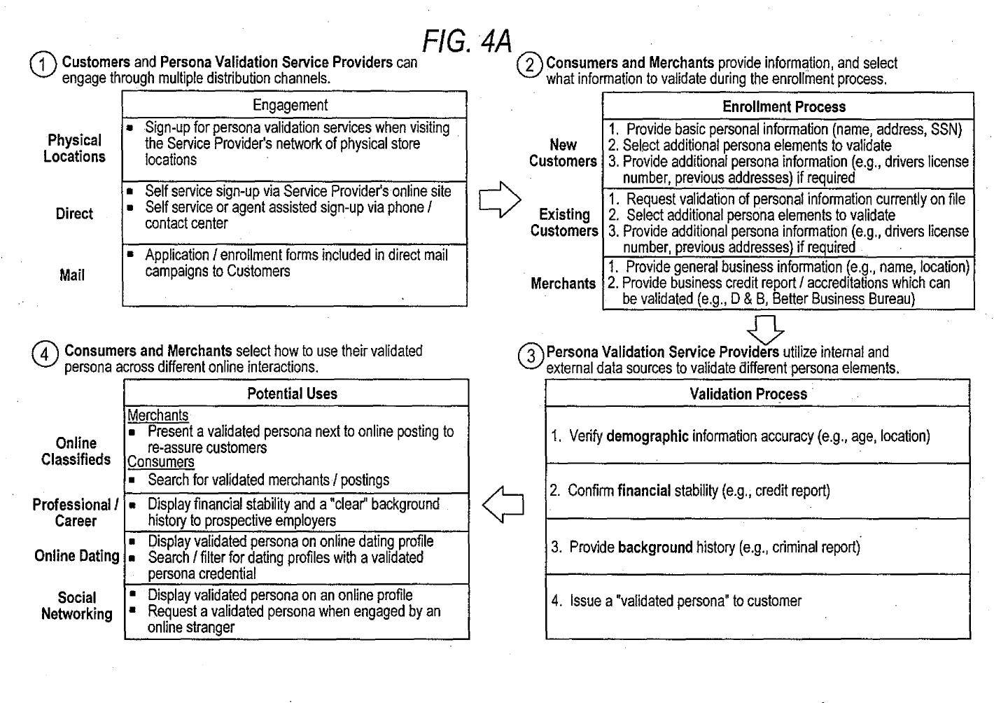

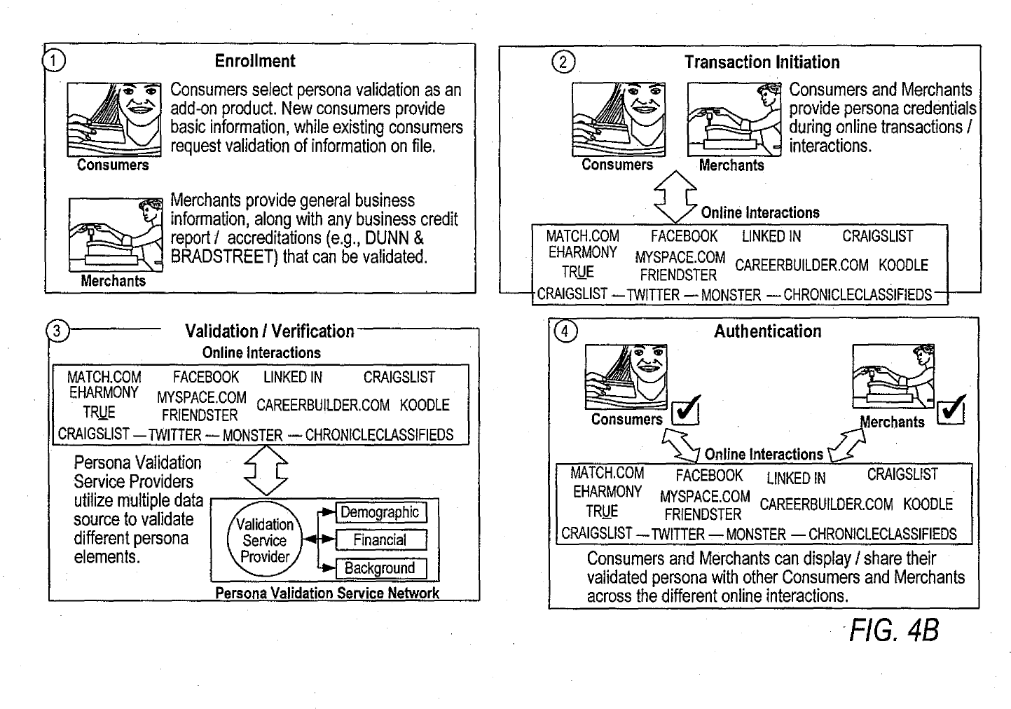

In exemplary embodiments of the present invention, a process for validating and leveraging multiple persona elements can be provided that has application across many different online interactions. This embodiment is shown in FIGS. 4A and 4B.

Referring to FIGS. 4A and 4B, in a first step, users and a persona validation service provider can engage through multiple distribution channels. For example, users (who can be, for example, both individual consumers as well as merchants) can sign up for persona validation services in person, online, via telephone or via mail. As part of the enrollment process, users can select and provide information to validate. For example, new users are prompted to provide basic personal information (e.g., name, gender, race, marital status, date and place of birth, citizenship, address, social security number). In addition to basic information, both new and existing users can optionally select further persona elements of varying levels of granularity to validate (e.g., educational attainment, income, home ownership, employment status/location, disabilities, mobility (i.e., travel time to work or number of vehicles available)), and then provide further persona information as necessary or appropriate (e.g., previous addresses, driver license number, license plate number/characters, monthly income and expenses, total assets, debt and net worth—both current and historical). Users can even volunteer further persona information (e.g., user's lifestyle preferences, hobbies, interests, affiliations).

In a next step, employing suitable, known verification techniques and methodologies, the persona validation service provider utilizes internal and/or external data sources to validate the persona information provided. This can, for example, involve verifying demographic information accuracy (e.g., age, location), confirming financial stability (e.g., credit report), and obtaining background history (e.g., criminal report).

As part of the validation process, a validation service provider may come across various inconsistencies in the user's credit and financial data. For example, employment and address information may not be as current in the records of one credit reporting service as it is in another. Outstanding liabilities (e.g., mortgages) may have been paid off and released, but still listed. Such inconsistencies can be reported to the user with a request for the user's input as to accuracy, and then the validation service provider can ascertain which data is the most current and accurate. Moreover, any errors can be removed as part of the validation process, inasmuch as, given the ongoing activities it undertakes, the persona validation service provider is likely to have the most current credit report data available to it over and above credit reporting agencies. In various embodiments of the present invention, such error correction and updating of credit reports can be offered as an added benefit to a user, with or without a corresponding fee.

The validation service provider can automate the data validation process in various ways. For example, one or more algorithms can be used to automatically access any necessary data to verify the user's submissions. Such necessary data can include, for example, credit reports, county records data, state maintained licensing and corporate records databases and the like. For example, as concerns a user's financial data, an algorithm implementing the following pseudo code can be used:

| // TotalRecord = all data provided by user; | |
|---|---|
| // FinMask = mask that can be applied to TotalRecord to isolate | |
| those fields relating to financial and credit information; | |
| //FinRecord = subset of TotalRecord with financial and credit | |
| information; | |
| //Results is a database storing the results of queries to | |
| // validation sources | |
| Begin | |
| input TotalRecord; | |
| apply FinMask to TotalRecord to obtain FinRecord; | |
| for each field in FinRecord | |
| for each verification data source | |
| {obtain data from verification source; | |
| store in Results;} | |
| compare fields in Results; | |
| set ResultsCompare | // 1= consistent; 0= |
| | // inconsistent |
| if ResultsCompare = 0 | |

| add field to inconsistency query list | |
|---|---|
| else | |
| set Verified flag | // 1 = user info verified; |
| | // 0 = user info incorrect; |

output list of fields for which Verified flag = 1;
generate communication to user re: inconsistency queries;
End

Similar processes can be used for, for example, validating subsets of the total data generated by a dating mask, employment mask and the like (after making sure that a field is not revalidated if it appears in two or more masks).

After the persona information is validated, including any follow-up validations as a result of the inconsistencies in databases used to validate user data, the validation service provider issues a validated persona to the user. That is, the validation service provider confirms that the user's verified persona information resides in secure, accessible (e.g., via the Internet) records on one or more databases associated with the validation service provider, and provides to the user means (e.g., an account identifier that can be provided to a third party Website) for authorizing automated access by third parties to validation information concerning a pre-selected portion of persona information (but not to the persona information itself). The issuance of a validated persona, permits the user to selectively advertise or otherwise communicate the fact that the user's persona information can be automatically validated (e.g., by online social and professional networking Websites) at the authorization of the user, as described in greater detail hereinafter.

It is contemplated that the user will also be provided with a PIN or other identifier to permit the user to access the validation service provider—e.g., to update, supplement, or otherwise modify the user's persona information, or to modify access permissions/restrictions (described in greater detail below). Also, it should be understood that persona information can be modified and new validations effected not only upon the initiative of the user, but in response to queries to validate persona information that is either not currently available in the validation service provider's database or has not been validated (e.g., if the user's marital status never needed to be validated until the user's first transaction with an online dating Website).

In a next step in the inventive process depicted in FIGS. 4A and 4B for validating and leveraging persona credentials, users choose how to use (display, share or otherwise communicate) their validated personas across different online transactions/interactions. For example, an individual user who chooses to interact with professional/career networking Websites can use his/her validated persona credentials to communicate financial stability, educational background and credentials and a spotless background history to prospective employers. A user who opts to interact with online dating Websites, for example, can use his/her validated persona credentials to communicate an online dating profile that can be relied upon; the user can also search/filter for dating profiles that have validated persona credentials. In the social networking arena, for example, a user can communicate that he/she has a validated persona on an online profile or request a validated persona when engaged by an online stranger. For a merchant user, the validated persona can be touted, for example, in association with an online posting such as, for example, an online classified advertisement, to assure customers that they are dealing with a legitimate individual, and to attract those who are searching specifically for merchants who have validated personas.

From an operational perspective, the Website with which a given user having a validated persona interacts can verify the user's credentials automatically. For example, the Website's server can access and query (e.g., via the Internet) the validation service provider's server to obtain validation of the user's credentials based on the user's validated persona information.

Preferably, the Website provider, recognizing the benefits of transacting with users who have validated personas, will already support, e.g., through software provided by the validation service provider, the automatic generation and communication of proper validation requests to the service provider in accordance with pre-defined protocols. Also, suitable security protocols (e.g., utilizing digital certificates or the like) can be put in place to ensure the authenticity of the transacting parties.

Access to validation information concerning a user's validated persona information can be subject to the authorization of the user. That is, a validated user visiting an online social or professional networking Website, for example, will provide his/her account identifier to the Website only after receiving some form of assurance that the Website will seek verification of only those verified persona elements that the user has specified for release to the Website (e.g., the user selects certain items that he/she is willing to have validated from a list of items). As a further security feature, upon receipt of a query from a Website, the validation service provider can automatically send an e-mail or other communication to the user identifying the nature and scope of the query and seeking authorization from the user prior to providing validation information in response to the query.

As an additional control, which can be used in place of or in addition to the security measures described above, access to and use of the stored persona information can also be governed by granularly adjustable automated rules on the service provider side. Preferably, for each user record resident on the validation service provider's database, rules-based permissions and/or restrictions are provided (e.g., contained in associated fields). An example of a restriction would be a rule (user-specified) that the service provider will never respond to validation or other queries originating from a particular Website or class of Websites. An example of a permission would be a rule (user-specified) that pre-selected validated information concerning the user (e.g., name and e-mail address) may be released to certain advertisers, such as, for example, sports ticketing services, to enable such advertisers to consider the user for targeted offers. Another exemplary rule would be that for each of a defined type of Website, only a subset of the user's total record would be accessible. The user can set which of his or her validated fields can be provided to each Website type. For example, regardless of which types of validated data are requested by a dating Website, a user can set a rule that only marital status, age, profession and residence location be provided, thus shielding all financial data from such queries. Such rules can be implemented by the use of masks (as described above) which, operating on a user's total validated data record, can select a relevant subset. In this regard a DatingMask, FinMask, EmployerMask, etc., can be defined. Each incoming query can be identified as to type, and using such type value the relevant mask can be used to generate a subset of user data that is available to respond to the query. If the incoming query is, for example, from <e-harmony.com>, <match.com> or <plentyoffish.com>, then only those fields that pass through the DatingMask (and no others) are available to respond to the query.

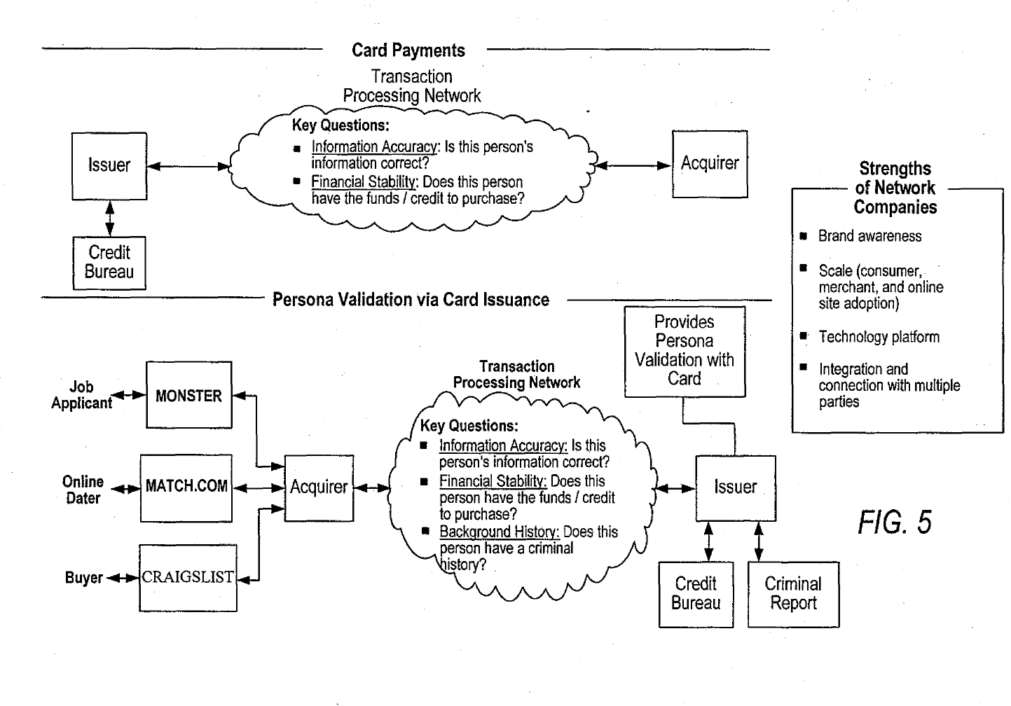

Advantageously, persona validation in accordance with embodiments of the present invention can be provided as an add-on product associated with a credit card, bank card or the like to enhance the value of the card to both the card holder or user of the card and to the bank, financial institution or other issuer of the card. Indeed, as illustrated in FIG. 5, card issuers are particularly suited to offer persona validation in accordance with the present invention given their access to a well-developed infrastructure that supports card issuance and processing and transaction settlement, and that, of necessity, already involves validations of the credit worthiness (e.g., credit report) and background history (e.g., criminal report) of card holders.

It should be appreciated that, from the card issuer's perspective, providing persona validation as an add-on product can offer not only the benefit of product differentiation, but further engenders both transactional and non-transactional benefits. Transactional benefits include increased revenue resulting from increased transactional volume from new card holders who desire persona validation and from increased usage from existing card holders. Non-transactional benefits include direct revenue (e.g., fees) as consideration for providing persona validation, as well as the opportunity to realize revenue from the more granular user information provided in connection with persona validation in accordance with the present invention, which enhances segmentation capabilities. As described above, as an incidental service to the validation process, a fee can be charged for updating any inconsistencies across various databases accessed in the validation process, and correcting any erroneous information stored in such databases, such as in the case of multiple credit reporting databases. This is a task most consumers would rather not handle for themselves, and would be willing to pay for once they are advised that their credit reports may have errors. Also, consumers will appreciate that a large entity acting as validation service provider will be able to significantly more efficiently resolve such credit report data errors than the individual consumer. Additionally, because most, if not all, of the necessary data to underwrite a mortgage is customarily submitted for validation by users, a non-transactional benefit can, for example, be mortgage pre-approval. Many credit and bank card issuers themselves, or closely related entities, are in the business of mortgage issuance. Once users submit employment, income, outstanding debt and net worth information to be validated, a bank can access such data, once validated, and automatically run algorithms on the appropriate set of data fields (e.g., derived from the total record using a “MortgageApproval” mask) to determine whether the user is approved for a mortgage, be it new or a refinance of an existing mortgage or combination of existing mortgages, or a home equity loan. The bank can then offer the user a mortgage or home equity loan up to a maximum amount on a very short approval timeframe, inasmuch as the bank has already performed the underwriting using the user's validated data. Such offers can be routinely made if a user qualifies, or can be triggered upon analysis of other data, such as, for example, time of last refinance, existing interest rate(s) on the user's outstanding debt, significant recent increases in property values in the user's zip code, etc.

From the perspective of the user (card holder), persona validation from a card issuer represents a valuable add-on product from a reputable source that permits the use of a single, validated persona across multiple segments. From the perspective of the merchant user, the provision of persona validation can represent not only new customers and increased transactions, but also access to more complete customer information.

In addition to card issuers, in exemplary embodiments of the present invention another potential provider of persona validation services can be, for example, a global package shipper. Similar to card issuers, global package shippers currently maintain a well developed infrastructure to track and support the shipping of millions of packages from multiple parties with varied levels of service. It is thus noted that from a shipper's perspective providing persona validation as an add-on service can, for example, both increase their shipping traffic and allow them to further differentiate themselves as the Internet's leading shipping provider. From an end user perspective, similar again to a bank, the ability to use the shipping services of the provider across multiple vendor entities on the Internet can be highly desirable.

From the perspective of Website providers, persona validation can also represent access to more complete customer information (for better customer micro-segmentation and more targeted advertising), as well as increased site traffic and increased advertising revenue. Indeed, it should be appreciated that, by virtue of the customer micro-segmentation benefits presented by the present invention, online advertisers would be willing to pay more for each user view/click-through (the increase in advertising revenue can be shared with the validation service provider, as the validation service provider created that value).

It should be understood that the foregoing benefits are not unique to a credit card implementation of the present invention. Such benefits can equally apply to other implementations of the present invention.

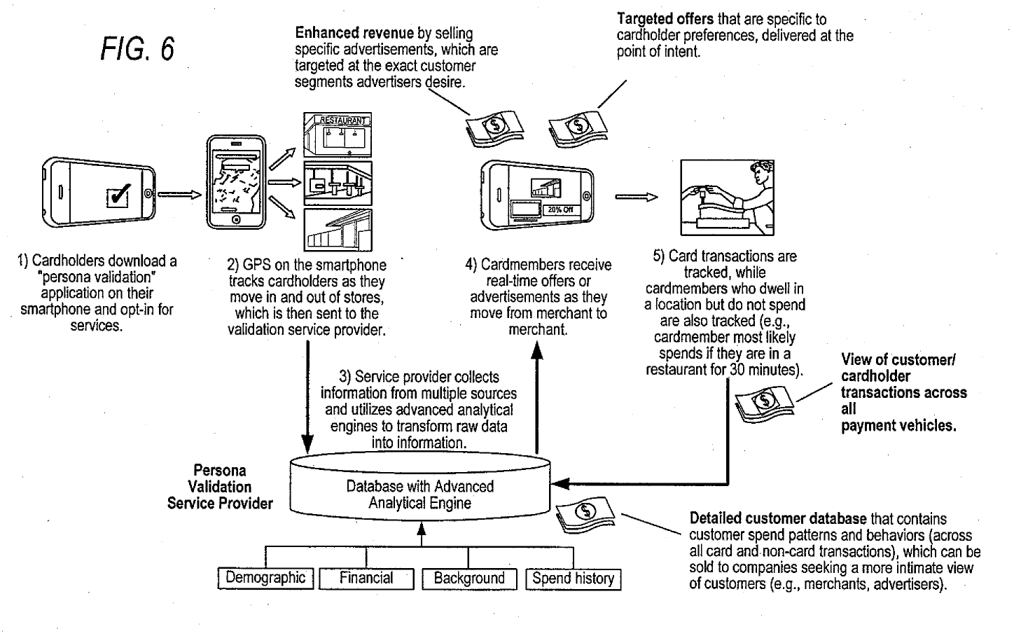

Referring now to FIG. 6, in accordance with an alternative embodiment of the present invention, a user can download a persona validation software application on his/her smartphone or like device and opt-in for services (step 1). The user authorizes the validation service provider to collect and the provider collects data concerning, for example, the user's movements (e.g., shopping, commuting), which can be obtained, for example, via the smartphone's GPS function (step 2). The service provider employs known computerized analytical processing methodologies to transform such data (in combination with other user persona validation data such as, for example, demographic data, financial data, background history and spending history) into useful, reliable information regarding the user's behavioral patterns of interest to advertisers and the like (step 3). This information can form the basis for real-time, targeted advertising or offers that are specific to the user's preferences delivered at the point of intent (step 4)—subject to the user's prior, and selective, authorization to release such information for such purposes. Additionally, the user's credit and debit card transactions can be tracked (and Level 1, 2 and 3 data collected, for example), and can be analytically related to the GPS data and/or other motion tracking data (e.g., data obtained via the user's electronic toll collection account, such as E-Z-PASS, for example) to yield new and granular insights into the user's spending patterns and other behavior. It should be appreciated that it is the unprecedented level of granularity of the persona data that can be cultivated by the persona validation service provider that is of particular value to advertisers and the like.

It is noted that a unique capability of exemplary embodiments of the present invention is the ability to use location based information independent of a user's credit card (or debit card) transaction data. For example, if a user pays by cash at his or her restaurant of choice every day—Victor can use location based data from his or her smartphone to ascertain his or her lunch habits without the need to discern this information from specific card data. This feature allows Victor to fully operate even with customers who only use cash, or for example, prepaid debit cards or the like.

As one example of the salutary use of GPS or other movement tracking data according to the foregoing embodiment of the present invention, imagine a user who commutes by car weekdays from the suburbs to the city. The user's commuting behavior is gleaned and validated from the GPS data and other data (e.g., home address, work address and even electronic toll collection data) collected (with the user's prior authorization) by the persona validation service provider. Additionally, the user's credit card transaction history reveals that the user typically pays to have his/her car washed at a car wash located nearby the user's home address. This information would likely be of particular interest, for targeted advertising purposes, to a car wash owner located away from the user's home address but a short distance from the highway along the user's commute to work. That is, provided the user has authorized the persona validation service provider to release certain validated persona information to advertisers for purposes of, for example, presenting discount offers to the user, the advertising car wash owner can, for a fee, obtain the user's contact information from the persona validation service provider pursuant to a request to identify users who might be potential customers willing to receive targeted car wash discount offers. The user benefits by receiving the discount offer for a service that he/she might never otherwise have known was available along the user's commute, as users do not tend to stop at the various highway or parkway exists along their route to investigate available providers of goods and services. If the advertising merchants are located in a tax-free, or lower tax, commercial development zone that happens to be along a user's route, the benefit of shopping with such merchants is a useful boon to a user even with no additional discount offer.

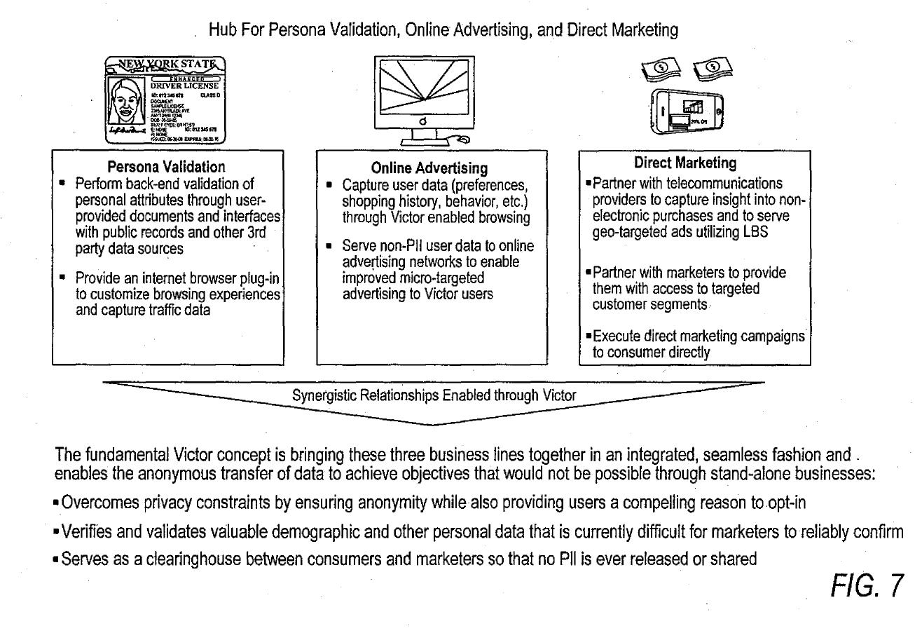

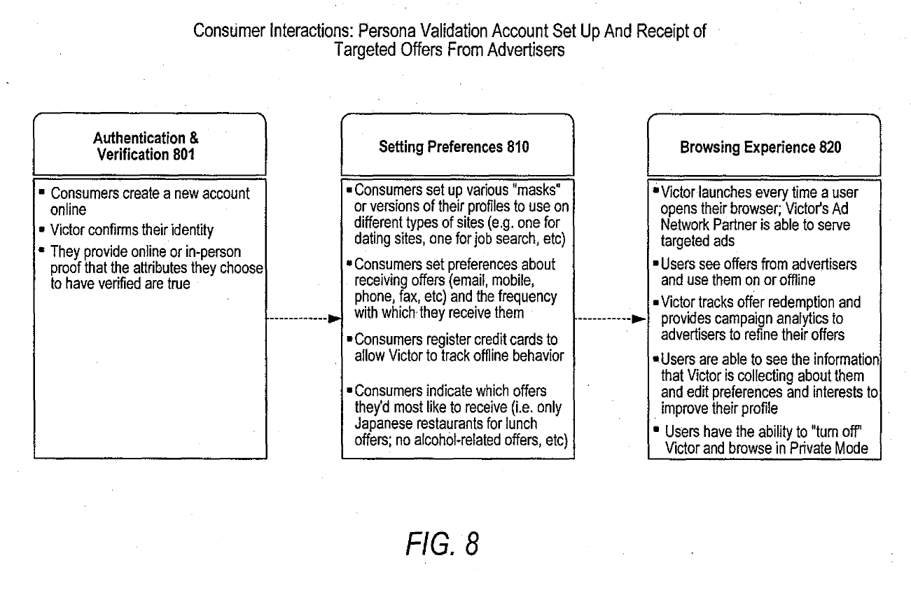

FIG. 7 illustrates how in exemplary embodiments of the present invention an exemplary system can serve as a hub for persona validation, online advertising and direct marketing. As a result, various synergistic relationships can be facilitated and enabled.

As shown in FIG. 7, an exemplary system can enable various synergistic relationships among persona validation, online advertising and direct marketing functionalities and sub-systems. These three business lines can thus be together in an integrated and seamless fashion and enable the anonymous transfer of data to achieve objectives that would not be possible through standalone businesses. For example, such a synergistic system (i) overcomes privacy constraints by ensuring anonymity while at the same time providing users a compelling reason to opt-in, (ii) verifies and validates valuable demographic and other personal data that is currently difficult for marketers to reliably confirm, and can, for example, (iii) serve as a clearinghouse between consumers and marketers so that no PII is ever released or shared.

FIG. 8 illustrates various consumer interactions according to exemplary embodiments of the present invention. As shown therein, there can be, for example, an Authentication and Verification interaction 801, a Preferences Setting interaction 810, and a Browsing Experience interaction 820 for each user. In Authentication and Verification 801 a user can create a new account, and his or her data can then be verified. Then, in Preferences Setting interaction 810 the user can set various masks to show/shield various subsets of their verified data, set preferences regarding receiving various offers and the frequency of such receipt, can register various credit cards for which offline behaviors can be tracked, and can indicate which offers they are most interested in receiving.

Finally, in a Browsing Experience interaction, Victor can, for example, launch every time a user opens their browser. Additionally, an Ad Network Partner can serve targeted ads, and a user can see offers from advertisers and use them either on or offline. In addition, Victor can track offer redemption and provide campaign analytics to advertisers to aid them in refining their offers. In exemplary embodiments of the present invention, users can, for example, see the information that Victor is collecting about them and edit preferences and interests to improve their profile—and thus the quality and value of advertisements and promotions directed to them. Finally, for example, users can have the ability to “turn off” Victor and browse in a “Private Mode.”

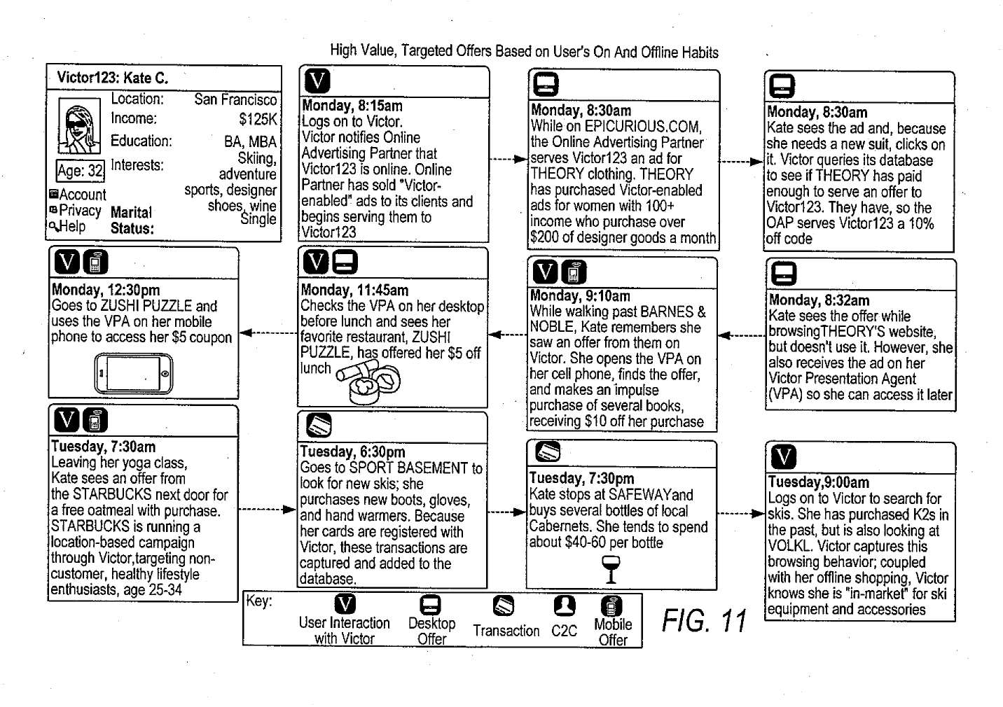

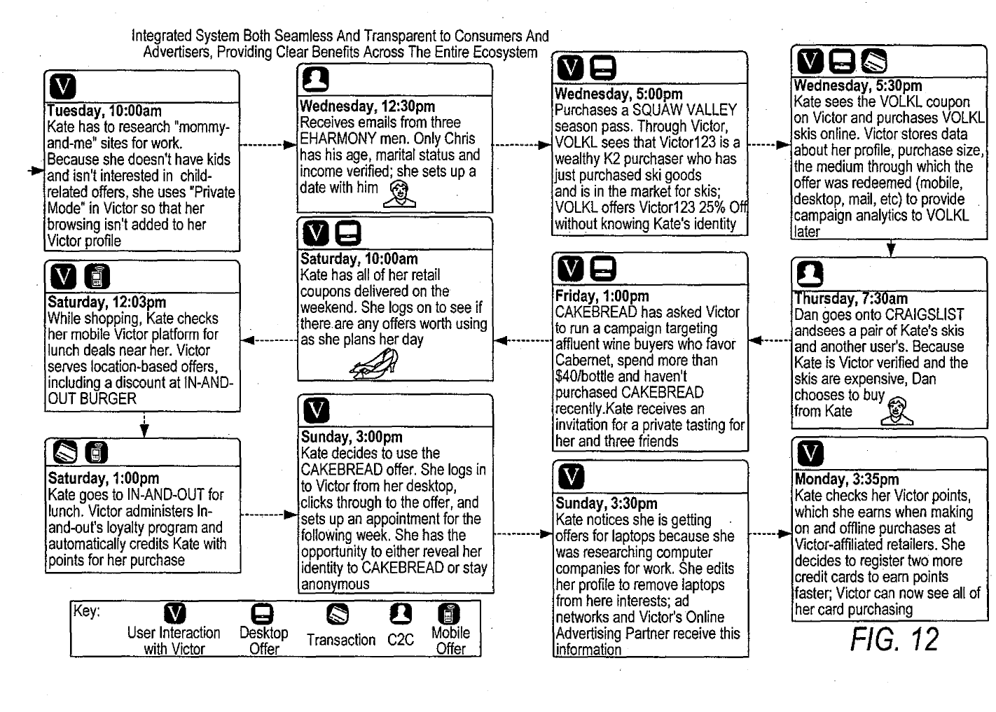

As seen in FIG. 7 as well as in FIGS. 11-12, for example, in exemplary embodiments of the present invention targeted advertisements are sent to a Victor user based on a large amount of data collected regarding the user's online as well as off-line activities. It is often desired by advertisers that such ads be delivered rather quickly once the data triggers one of the advertisement generation algorithms (“AGAs”). At the same time, it can well be appreciated that very large amounts of data are collected and managed with regard to each and every Victor user. Thus, if a given AGA had to search through a single, rather large, data record for each user, the time required to generate such advertisements can often far exceed the allotted time that the advertiser contracts for.

Thus, in exemplary embodiments of the present invention, the data that is collected and stored for each user can be micro-segmented, and each micro-segment or “slice” of data can be stored in a separate, small, and easily accessible data record or attribute table. There can thus be, for example, numerous such attribute tables for each user, and thus a given user's overall profile is distributed across numerous such attribute tables. For example, all sports related attributes can be stored in one table, and advertisement generation algorithms (also known as “ad agents”) relating to the sports micro-segment need only search such a relatively small attribute table.

Similarly, for example, all restaurant related data for a user can be stored in a separate table. Such small attribute tables are easier to search on, and can be stored in near memory, thus not requiring disk accesses. Moreoever, for example, the entries in each table can be numeric, thus facilitating quicker searching. For example, the restaurant attribute table can have a number of fields corresponding to food genres, and for each field a 1 or 0 can be stored, corresponding to a YES or NO for a user liking that type of food or disliking it.

Thus, for example, one might see a restaurant preference table having, in addition to other fields, such as, for example, residence and work locations of user and his/her spouse, restaurants frequented in last year, etc. the following fields:

| | |
|---|---|
| Italian | 1 |
| Sushi | 1 |
| Chinese | 1 |
| Moroccan | 0 |

Such a listing can prioritize YES data by order in which it appears, such that, for example, the above exemplary user's favorite food is Italian, second favorite is Sushi, and third favorite is Chinese, and the user dislikes Moroccan food. Or, for example, greater gradations can be stored in larger numbers of bits, corresponding to shades of like or dislike.

It is noted that locational data, such as a user's residence and work locations, and those of his spouse, for example, although stored in a user's primary table, can also be imported to his restaurant attribute data slice. Thus, data can be repeated in various tables, and there can be, for example, a background process that continually moves or migrates data from primary tables to slices, as may be needed. Thus, by utilizing such micro-segmentation so as to have multiple smaller attribute tables, by storing such smaller tables in near memory, and by having a background data management/migration process to service the data slices as needed, in exemplary embodiments of the present invention an ad agent is provided with very fast searching of relevant data, and thus the ability to have a very fast response. Examples of this are provided below in connection with FIGS. 11-12.

Indeed, new or additional micro-segments can be created “on the fly” as new advertisers, with new input criteria for their ad agents, are signed up to work with an exemplary system. For example, an exemplary Victor system may partner with an affinity credit card issues to all graduates of Columbia University. From its profiles of existing users, Victor happened to know that many of its users fit this category, which gave it an edge in negotiating the new arrangement with the affinity card's issuing bank. Given the new relationship, Victor may create a new “Columbia University” attribute table, where it stores year graduated, whether the user supports the various sports teams at Columbia, whether any children currently attend, and average purchases by type and dollar amount at the Columbia University bookstore. Then, whenever a significant reunion year occurs, or, for example, when football season starts, various advertisements and promotions for shirts, hats, mugs, etc. with “Columbia Lions” or “Class of 1982”, for example, can be targeted to such users.

In this manner the types of offers as well as the types of advertisers can evolve over time, and an exemplary Victor system can respond appropriately to service the ad agents.

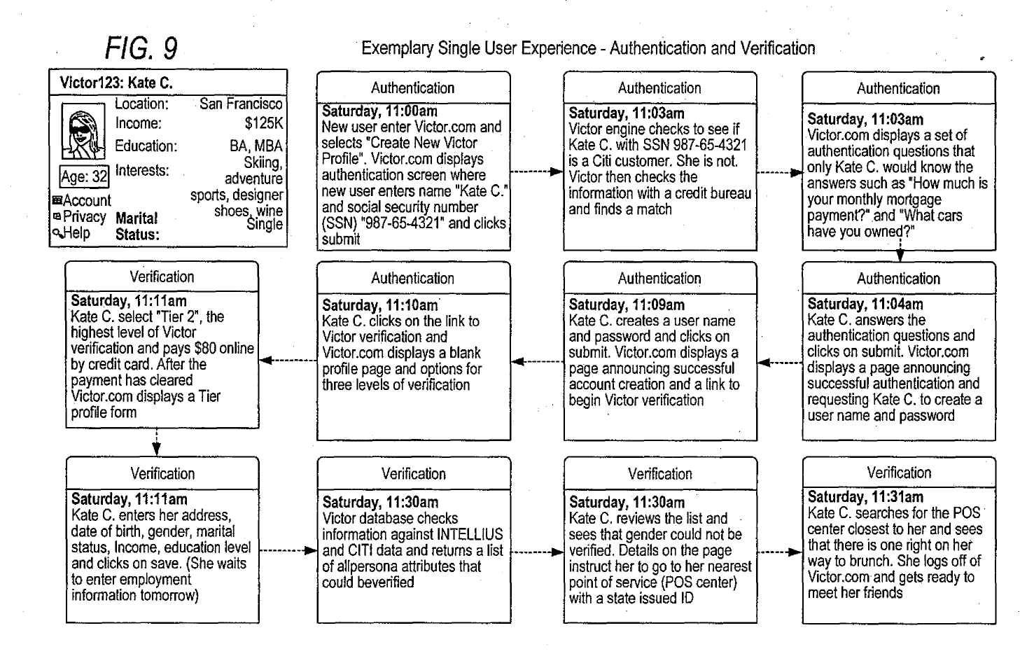

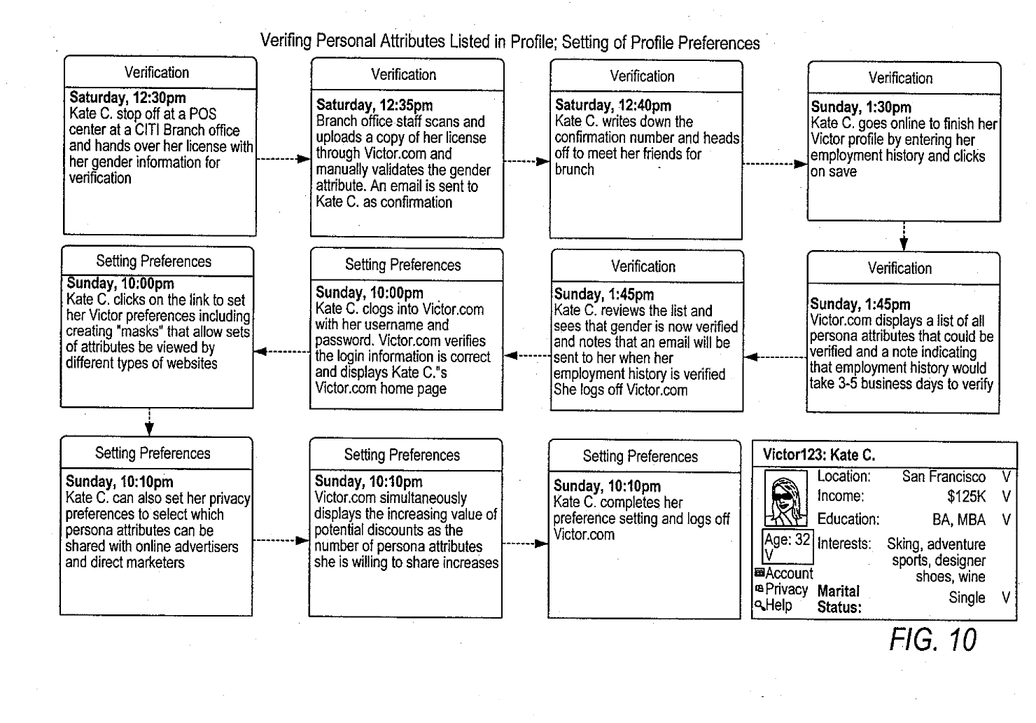

FIGS. 9-12 illustrate an exemplary single user experience according to an exemplary embodiment of the present invention. In FIGS. 9-10 a fictitious user named “Kate C.” signs on to an exemplary system as username “Victor123”, and goes through an initial authentication process and an exemplary verification process. Our exemplary user Victor123 has chosen the highest level of verification, as described in detail below.

In each of FIGS. 9-12 it is noted that the various boxes occur chronologically, and moreover, they should be read in a “boustrophedon” or bidirectional manner. Thus, for example, in FIG. 9 the boxes should be read form the start in the upper left corner, proceeding in the first row from left to right, then down to the beginning of the second row at the right, and then proceeding right to left until the beginning of the third row, at its left, and then left to right again.

The events of FIG. 9 occur within a half an hour of time on one day, Saturday. FIG. 10 follows Kate C. as she completes the Verification and Setting Preferences Interactions over Saturday and Sunday, her last preference setting task finishing on Sunday at 10:10 PM. As shown at the bottom right of FIG. 10, after completing the Verification interaction, Kate C.'s age, location, income, education and marital status are now displayed as “V” or verified.

FIGS. 11-12 then follow Kate C. through an additional eight-day period as a new Victor user, beginning on Monday morning at 8:15 AM and continuing through to the following Monday at 3:35 PM, a week later. During this exemplary week-long time interval, Kate C. receives a number of offers across a wide network of purveyors and merchants of various goods and services. Additionally, various targeted advertisement generation algorithms (ad agents) are busily at work providing Kate C. with high-value targeted offers, based on both her on-line as well as her off-line habits. These various advertisements and coupons are delivered to Victor123 as she goes about her day, and come via her desktop computer, her mobile device (smart phone, blackberry, phone, iPAD, etc.), all as depicted in FIGS. 11-12.

As exemplified in FIGS. 11-12 via the activities of Kate C., it is envisioned that most of the attributes regarding a user that Victor learns are actually learned through her on-line (Browsing Experience) and off-line (purchases with Victor registered credit cards, use of Victor-sent coupons, etc.) activities. Thus, the more a user does, the more data Victor can analyze regarding that user (or groups or cohorts of similar users) and the better Victor's ad agents can be.

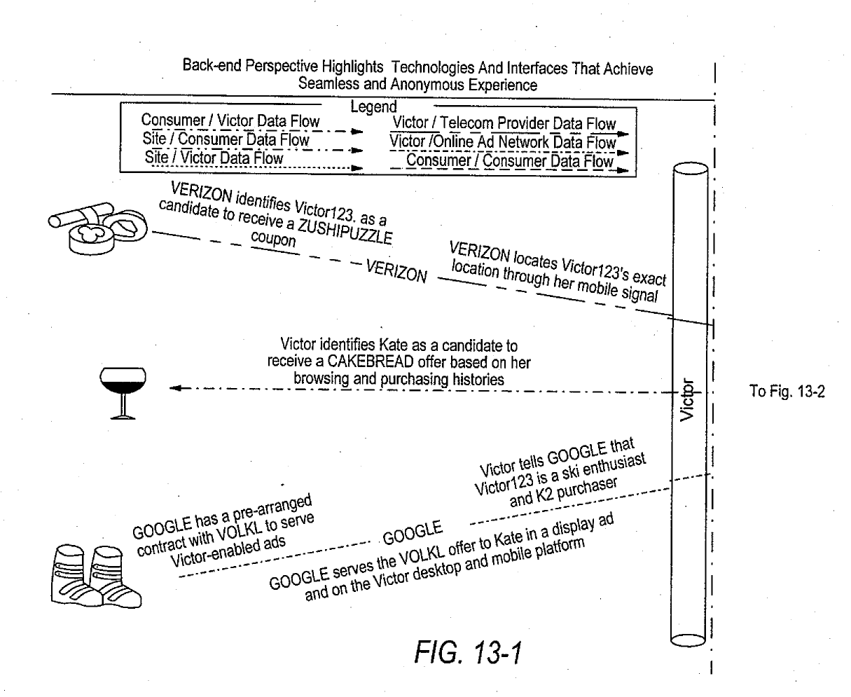

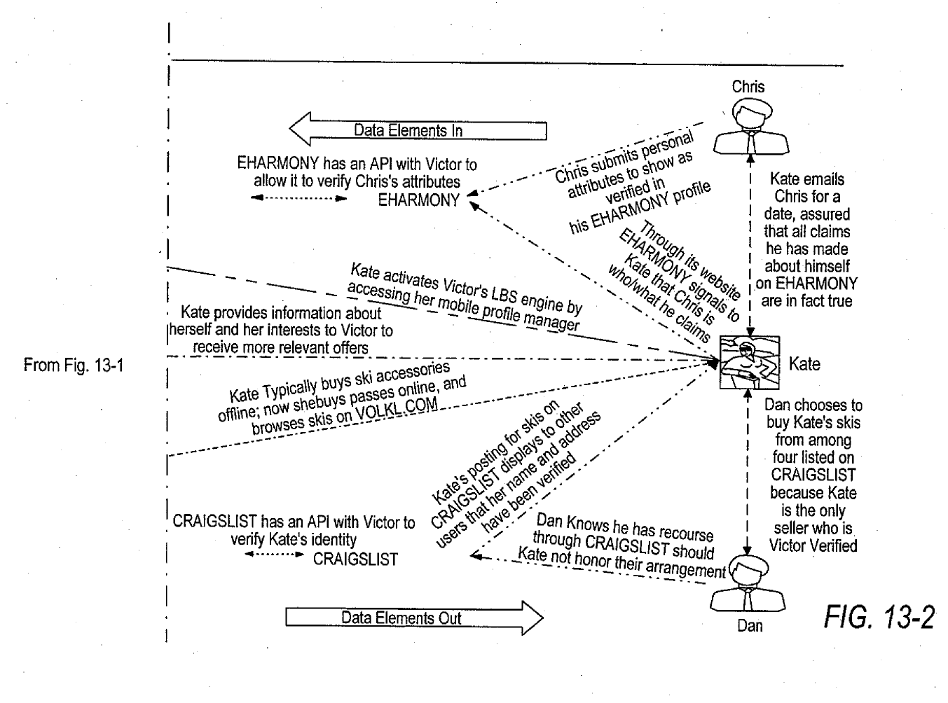

FIG. 13 depicts exemplary back-end technologies and interfaces used to support a seamless and anonymous experience for Kate C. There are shown six different data flows and associated processes, illustrating the use of an exemplary system as a veritable hub connecting a vast network of people, users, merchants, data and activities. As can be seen in FIG. 13, one of the depicted data feeds is (i) a Victor/Telecom Provider Data Flow. In exemplary embodiments of the present invention, this data feed can, for example, supply Victor with a user's moment to moment location information based on her mobile signal. This is not only a massive data feed, but when processed it can send highly relevant location based advertisements, and even “anticipate” a user's next move. This can offer a very valuable opportunity for targeted advertisements, and an immediate calculation of response time. Thus, for example, in FIG. 12, at 11:45 AM on Monday Kate C. is sent an offer from her favorite restaurant “Zushi Puzzle”, delivered via the Victor Presentation Agent. She uses it at 12:30 PM via her mobile phone.

Alternatively, it may be that she gets on the phone at 11:55 AM and is clearly walking around in a mall, where there is no Zushi Puzzle. Victor can then adaptively send her a new lunch offer from Sbarro's, which Victor knows has a location at the mall Kate C. has decided to go shopping in during her lunch hour.

When Kate C. leaves the mall, advertising analytics can register whether or not she redeemed it, thus offering highly granular response information.

In that regard, it is noted that in exemplary embodiments of the present invention advertising analytics can be stored in yet separate tables from the main profile and the various data slices, or attribute tables. Such an advertising analytic table can include, for example, offers sent, frequency of offers sent, when used/executed by user, statistical analyses of this user vis-à-vis other users sent the advertisement, etc.

Continuing with reference to FIG. 13, there are also shown (ii) a Consumer/Victor Data Flow, (iii) a Victor/Online Ad Network Data Flow, illustrated by a ski merchant issuing an offer to Kate C. on both the Victor desktop and mobile platforms, (iv) a Site/Consumer Data Flow, illustrated by an e-Harmony user named Chris validating data on e-harmony via a Victor API and Victor then advising Kate C. that Chris is who he claims to be, (v) a Site to Victor Data Flow, illustrated by e-Harmony and Craigslist sharing information with Victor via a validation API, and (vi) a Consumer to Consumer (“C2C”) Data Flow, illustrated by the e-Harmony user Chris and a Craigslist user Dan, having direct contact with Kate C., once Chris and Kate C. are Victor verified.

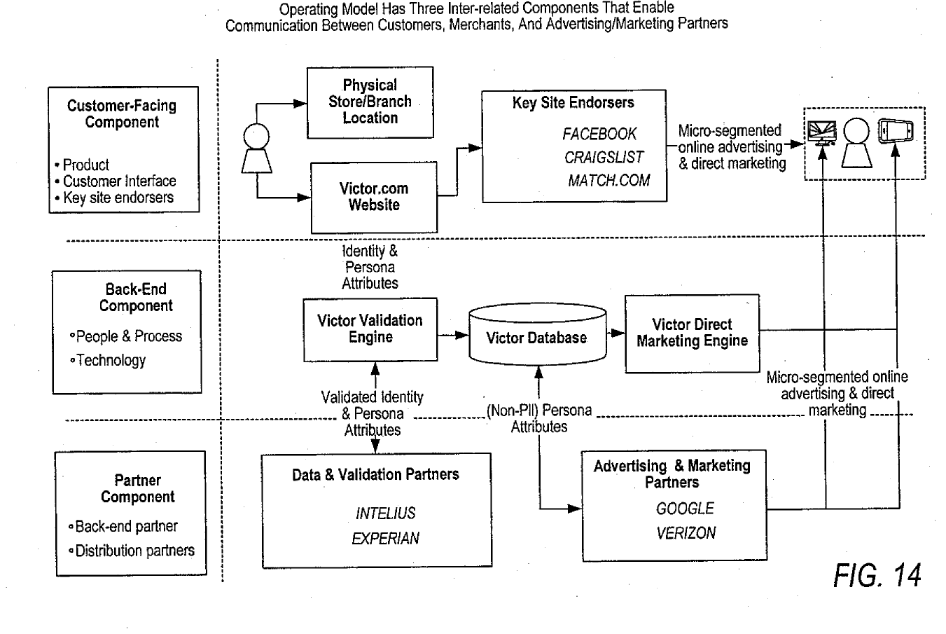

FIG. 14 illustrates using three inter-related components enabling communications between customers/users, merchants and advertising/marketing partners according to an exemplary embodiment of the present invention. These components themselves each comprise a customer facing component, a back-end component and a partner component. The exemplary customer facing component can include, for example, a physical store or branch location, where a Victor user can go to supply physical documents as part of her validation on Victor. Such documents can be scanned or otherwise digitized, and then stored and available to Victor's various processes as may be needed. The exemplary customer facing component can also include, for example, a system website where a user interacts with an exemplary system, as well as key endorsers, such as, for example, Facebook, Craigslist, e-Harmony and Match.com, who receive user information form the exemplary system and then generate targeted advertisements, offers or the like to users.

Continuing with reference to FIG. 14, the exemplary back-end component can comprise, for example, a Validation Engine, a System Database and a Direct Marketing Engine. This component receives a user's identity and persona attributes, and validates them, then communicates the validated user data to the system database, which can store the data in various ways, such as in a primary attribute table and multiple micro-segmented attribute tables, as described above. The Direct Marketing Engine, for example, receives user data form the system database, and then processes it to generate direct marketing solicitations, promotions and offers to a system user, as shown. Finally, an exemplary Partner Component can include, for example, Data and Validation partners, such as data compilers, credit bureaus and credit reporting services such as Intellius and Experian, with whom data is exchanged regarding validation or user data, as well as Advertising and Marketing partners such as, for example, Google and Verizon, with whom data is exchanged so as to generate targeted marketing and advertising. It is noted that exemplary interactions with partners such as Google and Verizon are depicted in FIG. 13, in particular in the Victor/Online Ad Network Data Flow and the Victor/Telecom Provider Data Flow, respectively.

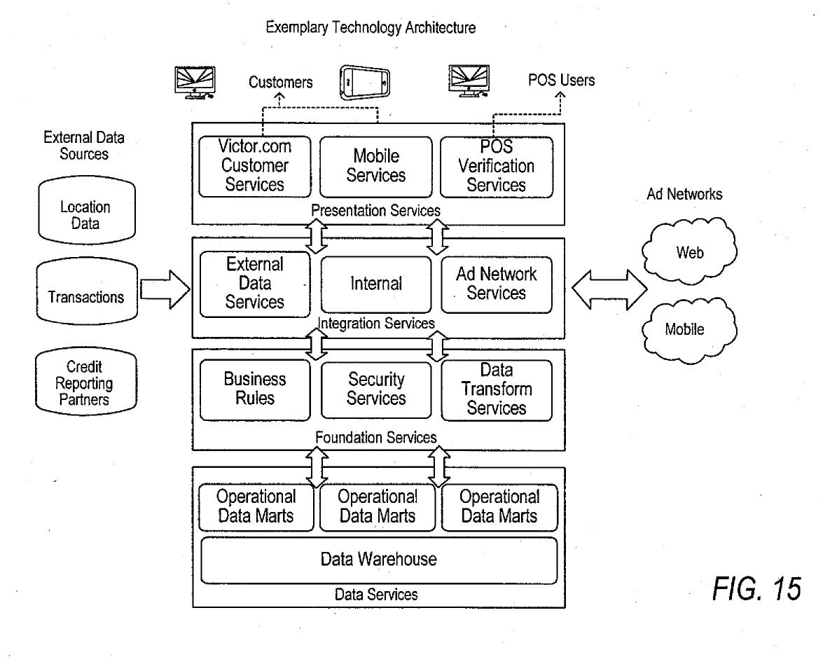

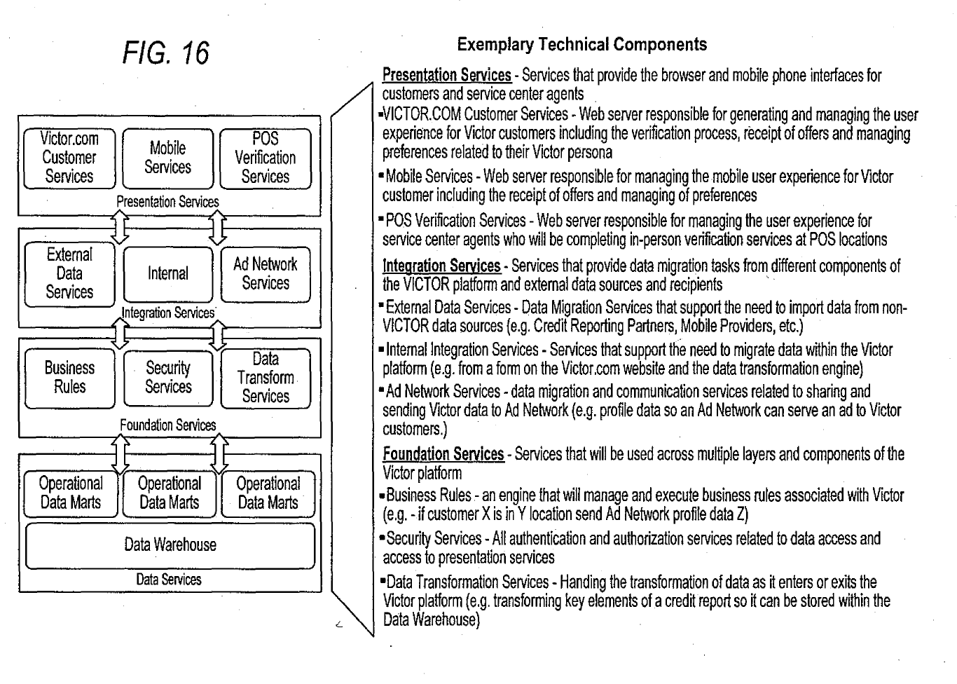

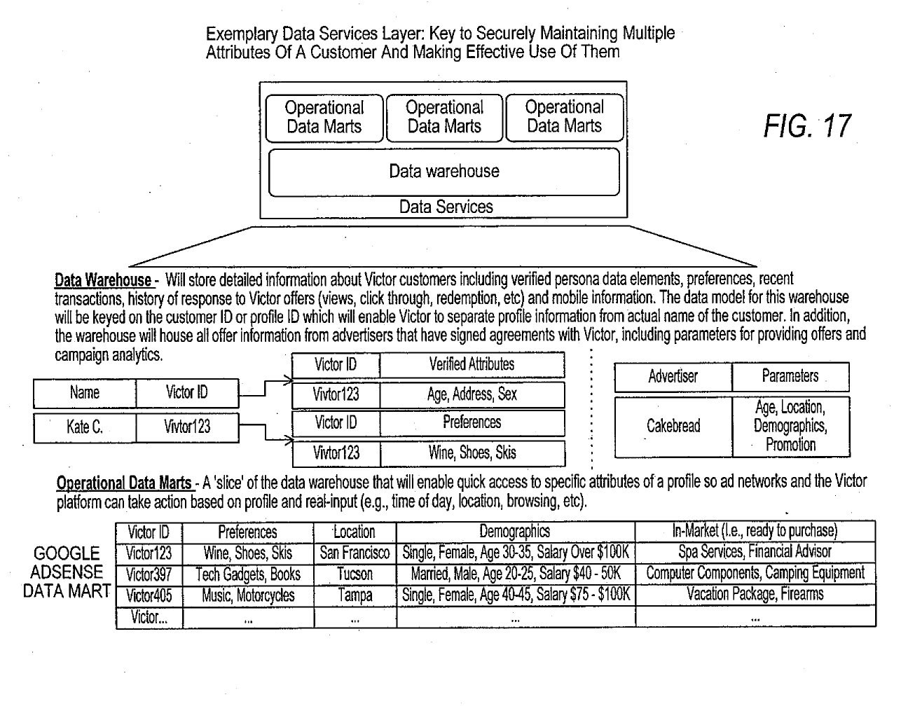

FIGS. 15-16 depict an exemplary technology architecture that can be used in exemplary embodiments of the present invention. With reference thereto, there are four service layers or modules, one for each of Presentation Services, Integration Services, Foundation Services and Data Services. As seen on the left of FIG. 15, a set of External Data Sources can provide data to the Integration Services module via an “External Data Services” sub-module, and, as shown at the right of FIG. 15, an “Ad Networks Services” sub-module can interact with multiple advertising networks, such as, for example, via the Internet and via mobile networks. It is noted that the various modules and sub-modules depicted are logical. Thus, in a given exemplary system, the various layers or modules shown can be implemented across numerous CPUs on independent servers, each providing some or all of the services associated with that module or sub-module. FIG. 16 depicts details of the various Presentation, Integration and Foundation Services Layers provided in this exemplary architecture, and FIG. 17 depicts details of the exemplary Data Services Layer shown at the bottom of FIG. 15.

With reference to FIG. 16, an exemplary Presentation Services Layer can include, for example, services that provide browser and mobile phone interfaces for customers and service center agents. Such services can, for example, include the following sub-modules:

Victor.com Customer Services—a web server responsible for generating and managing the user experience for Victor customers including the verification process, receipt of offers and managing preferences related to their Victor persona;

Mobile Services—a web server responsible for managing the mobile user experience for Victor customers including the receipt of offers and managing of preferences; and

POS Verification Services—a web server responsible for managing the user experience for service center agents who will be completing in-person verification services at POS locations,

In addition, an exemplary Integration Services Layer can provide data migration tasks from different components of the Victor platform and external data sources and recipients. Such an exemplary module can include the following sub-modules:

External Data Services—data migration services that support the need to import data from non-Victor data sources (e.g. Credit Reporting Partners, Mobile Providers, etc.);

Internal Integration Services—services that support the need to migrate data within the Victor platform (such as, for example, a form on the Victor.com website and the data transformation engine); and

Ad Network Services—data migration and communication services related to sharing and sending Victor data to Ad Network (such as, for example, profile data so an Ad Network can serve an ad to Victor customers).

Next, an exemplary Foundation Services Layer can provide services that will be used across multiple layers and components of the Victor platform, and can, for example, include the following sub-modules:

Business Rules—an engine that will manage and execute business rules associated with Victor (e.g. —if customer X is in Y location send Ad Network profile data Z);

Security Services—all authentication and authorization services related to data access and access to presentation services; and

Data Transformation Services—handing the transformation of data as it enters or exits the Victor platform (such as, for example, transforming key elements of a credit report so it can be stored within the Data Warehouse).

Finally, FIG. 17 depicts details of the final module, the Data Services Layer. With reference to FIG. 17, the Data Services Layer has two elements, Operational Data Marts and Data Warehouse. The Data Warehouse can, for example, store detailed information about Victor customers including, for example, their verified persona data elements, preferences, recent transactions, history of response to Victor offers (such as, for example, views, click through, redemption, etc.) and mobile information. The data model for this warehouse can, for example, be keyed on the customer ID (“Victor123”) or profile ID which can thus enable Victor to separate profile information from actual name of the customer. In addition, the warehouse can, for example, house all offer information from advertisers that have signed agreements with Victor, including their various contracted for or specified parameters for providing offers and campaign analytics. The Operational Data Marts are examples of the data slices described above. Each is a ‘slice’ of the data warehouse that can enable quick access to specific attributes of a profile so that ad networks and the Victor platform can take action based on the profile and real-time input (such as; for example, time of day, location, browsing, etc). In exemplary embodiments of the present invention, a separate Operational Data Mart can, for example, be set up for each partnered advertiser.

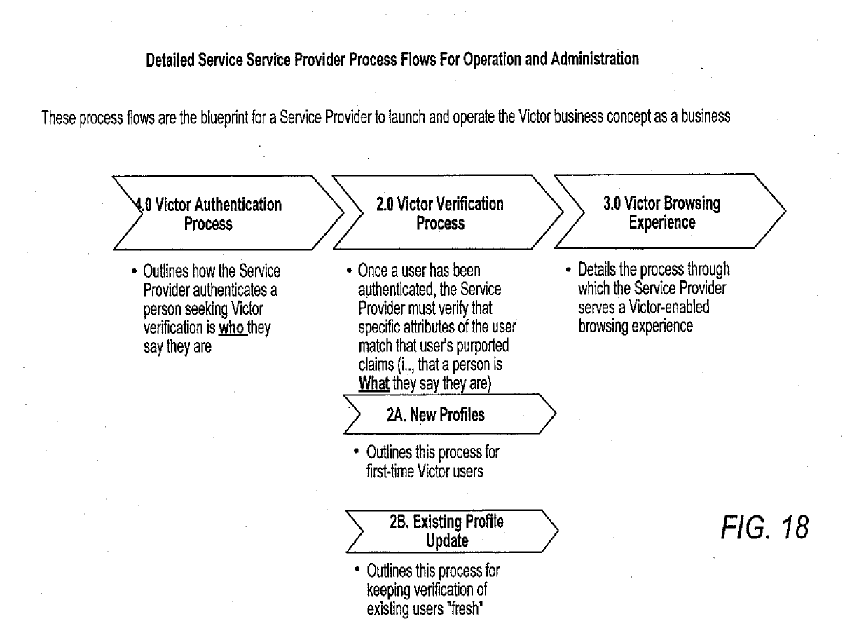

FIGS. 18-23 depict exemplary service provider process flows for operation and administration according to an exemplary embodiment of the present invention. These process flows relate to three main processes used in exemplary embodiments of the present invention, and are the backbone that delivers all of the functionalities and interactions such as are described in FIGS. 9-12 above.

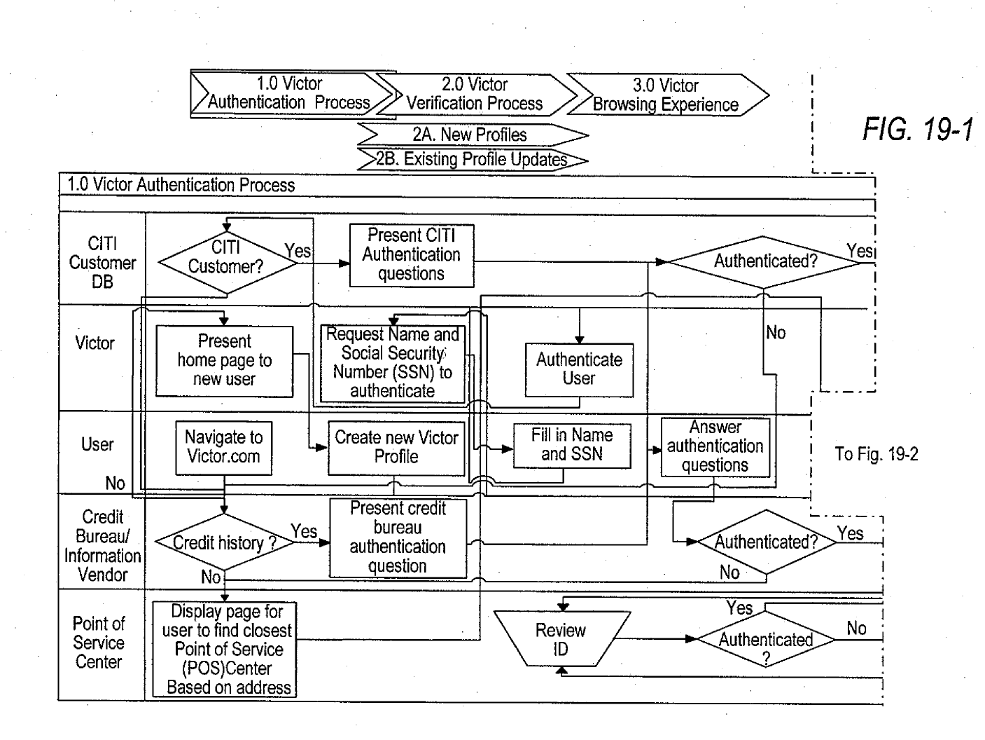

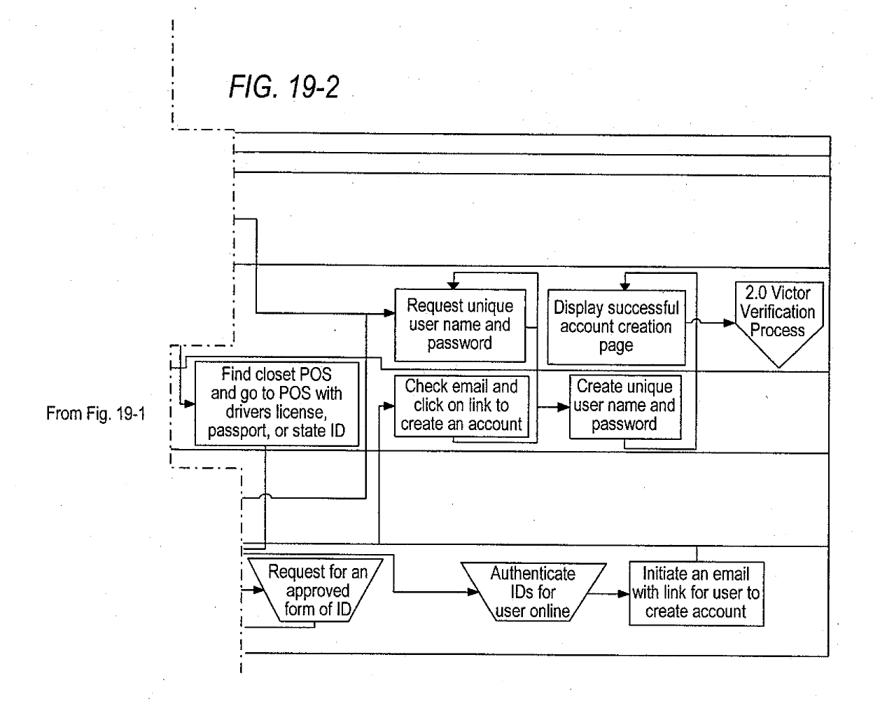

With reference thereto, FIG. 18 is an overview of the three main processes performed in exemplary embodiments of the present invention—Authentication, Verification and Browsing Experience. FIG. 19 provides details of the first process, the Authentication process. As can be seen in FIG. 19, and as is true for all of the processes depicted in FIGS. 18-23, there are processes and data flows that occur between five players: an exemplary bank, an exemplary system according to the present invention (“Victor”), a user, a credit bureau or information vendor, and a point of service center.

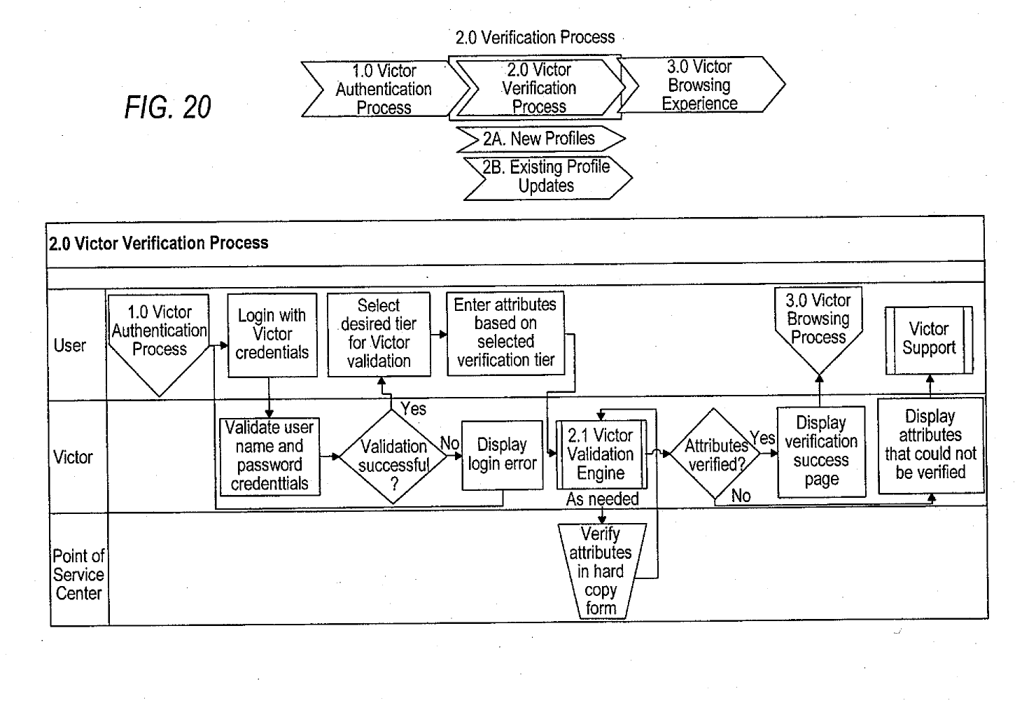

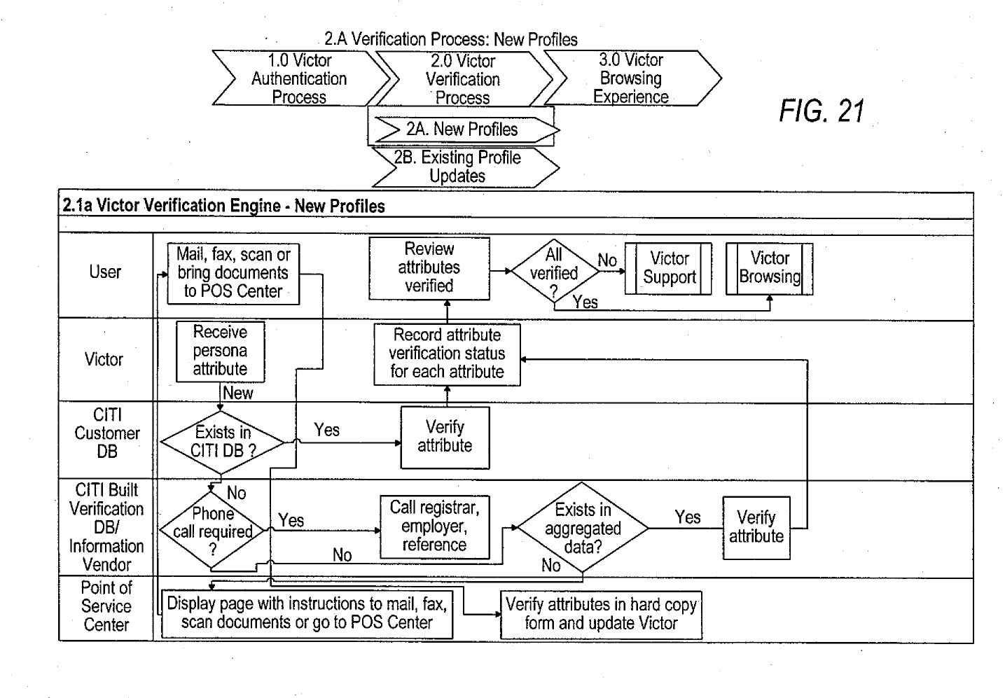

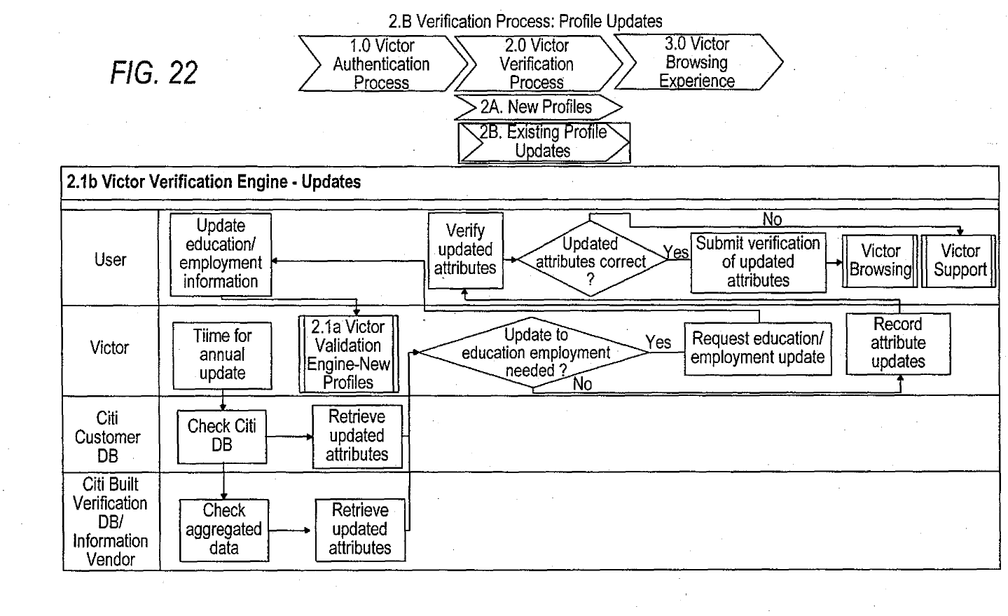

FIGS. 20-22 provide the processing detail for the various verification processes used in various exemplary embodiments of the present invention. FIG. 20 describes the general verification process. The workhorse of this process is a validation engine, which runs a set of algorithms used to verify the data provided by a user. The validation engine operates in two modes, depending upon whether the user is validating their data for a first time, i.e. their complete profile, as shown in FIG. 21, or whether they are simply submitting new data or version of data to a pre-existing profile, as shown in FIG. 22. Verifying a completely new profile involves the same five players depicted in FIG. 19, and as shown in FIG. 22, verifying a profile update involves all but the Point of Service Center. It is noted in FIGS. 19, 21 and 22 that an example is presented with a partner bank named “Citi.” This is for illustrative purposes only, and it is understood that any banking, financial, global shipping, or other partner could be substituted.

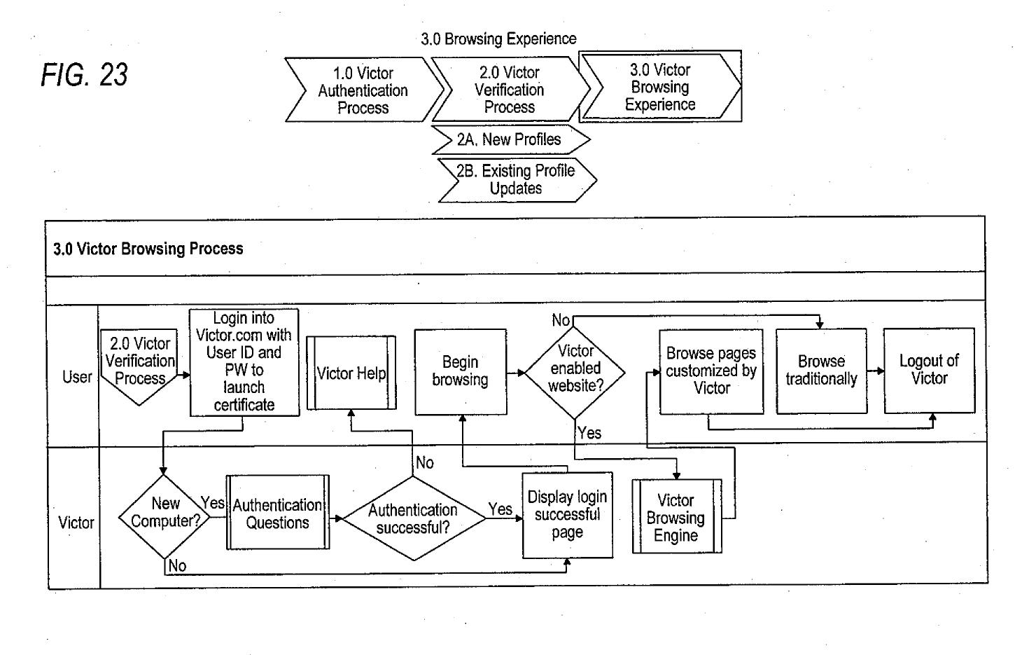

Finally, as described above, once a user's data has been verified, she can augment her Internet browsing experience with all the benefits that a Victor system can offer. Here the interaction is between the user and the exemplary system, as shown in FIG. 23.

### Novel Approach to Internet Based Services

Thus, in exemplary embodiments of the present invention, existing services and the end customer experience can be significantly changed from conventional approaches to Internet based interactions, services and commerce. As regards services, for example, such exemplary systems can provide multi-use Internet-wide trusted persona validation, micro-segment targeted ads and offers, and real time, location based, channel integrated ads and offers. A comparison of these functionalities with the currently available technology is summarized in the following tables.

### Persona Validation

| Current | Victor |
|---|---|
| No single trusted source for | Widely recognized standard for |
| verification (many providers); | validation and verification across |
| Site or usage specific | the entire internet with option for |
| validation (e.g., dating site | tiered verification system (see Appendix) |
| verification, Twitter | Social networks |
| verification) | Dating sites |
| | Employment sites |
| | Peer-to-peer commerce |
| Narrow verification set of | Wider scope of verification |
| attributes (typically limited | (i.e., name, address, age, |
| to name, address, age) | employment, income, education, |
| | criminal background etc.) |
| Verification done solely | Utilizes point of service centers |
| online; no in person | providing higher degree of |
| verification | surety and certainty information |
| | only verifiable in person |

### Online Advertising

| Current | Victor |
|---|---|
| Broad client/customer | Micro-segmenting informed by |
| segmentation with limited | demographic data, internet |
| user data information | browsing behavior, physical |
| | browsing behavior, as well as |
| | transaction history |
| Reliance on cookies for | Opt-in behavior of users |
| browsing history, although | expands the breadth and |
| many users choose to delete | accuracy of data collected. |
| cookie history | Highest level of confidence of |
| | data accuracy and |
| | comprehensiveness |

### Direct Marketing

| Current | Victor |
|---|---|
| Broad client/customer | Targeted micro-segmenting |
| segmentation with limited | informed by user-provided data, |
| user data information | internet browsing behavior, |
| | physical browsing behavior, as |
| | well as transaction history |
| | Near automatic/instantaneous |
| | analytic ability and targeting |
| Offers are made in non-real | Real-time and location-based |
| time and delivered location | delivery of offers |
| agnostic | |
| Offers delivered via non- | Channel-integrated and portable |
| integrated channels | offers (e.g., offers delivered via |
| | desktop, mobile, fax, mail and |
| | are synced among all devices) |

### Novel and Distinguishing Characteristics

Exemplary embodiments of the present invention allow the option for everything to be known about a user except who that user is. In addition, such exemplary systems can provide each user with full control over what data is shared and how it is being used. A comparison of these novel characteristics with the currently available technology is summarized in the following tables.

### Internet Anonymity

| Current | Victor |
|---|---|
| Opting-in to receive offers | Allows Victor users to receive |
| often requires a user to | offers and access to sites |
| provide PII | previously requiring PII, without |
| | needing to provide PII |
| Choosing to remain | Allows the option for everything |
| anonymous often precludes | to be accurately known about a |
| opportunities to receive offers | user except who the user is |
| and can also raise suspicions | |
| about claims to one's identity | |

### Internet Transparency and Control

| Current | Victor |
|---|---|
| Users are generally unaware | Enables Victor users to see |
| of what data is being | what data is being collected |
| collected on them | |
| Users cannot control what | Victor users can choose what |
| data is being collected and | data is being collected and see |
| how it is being utilized | how it is being utilized; users |
| | can also delete browsing history |

### Customer Loyalty

| Current | Victor |
|---|---|
| Individual companies run | Victor becomes loyalty program |
| loyalty programs | administrator for companies |
| | (without current loyalty |
| | programs or existing programs) |
| Companies collect customer | Enables counter offers from |
| information based on | competitors to a Victor user |
| customer interaction with their | based on user purchasing |
| company only | behavior (e.g., Charlie's Steak |
| | House will know that Victor 123 |
| | regularly spends $300 at Ruth's |
| | Chris and will make Victor123 |
| | an offer) |
| Customers must wait to reap | User is loyal to Victor rather |
| rewards (e.g., flying X miles | than a particular company |
| with a particular airline to get | because Victor provides a user |
| certain status, or staying Y | with offers rather than loyalty |
| nights with a particular hotel | points that a long time to earn |
| chain) | |

### Verification Tiering System

In exemplary embodiments of the present invention, an online persona validation business can, for example, offer various products aimed at different segments of the market. For example, the market can be divided into 3 tiers, each with more information being validated, and thus acquired. Such a three-tier example is summarized in Table I below, where, the three tiers are referred to for illustrative purposes as Tier 0, Victor Tier 1 and Tier 2.

TABLE I
Tiered Verification System

| | Attributes | | |
|---|---|---|---|
| Product | Validated | Benefits | Target Customers |
| Tier 0 | Name | Allows social and | Social networkers |
| | Address | professional | and users of online |
| | Age | networkers to trust | classified ads |
| | | their contacts | Parents/Children |
| | | “Traceable” | looking for |
| | | information for online | increased security |
| | | transactions | |
| Tier 1 | Name | Provides detailed | Online daters |
| | Address | personal information | |
| | Age | for online daters and | |
| | Gender | more personal | |
| | Marital Status | transactions | |
| | Income | | |
| Tier 2 | Name | Increases credibility | Job seekers and |
| | Address | for job seekers | employers |
| | Age | | |
| | Gender | | |
| | Marital Status | | |
| | Income | | |
| | Criminal Record | | |
| | Credit Check | | |
| | Education Level | | |
| | Complete | | |
| | Employment | | |
| | History/ | | |
| | References | | |

### Exemplary Systems and Implementation Technologies

In so far as embodiments of the invention described herein may be implemented, at least in part, using software controlled programmable processing devices, such as a computer system, it will be appreciated that one or more computer programs for configuring such programmable devices or system of devices to implement the foregoing described method embodiments are to be considered an aspect of the present invention. The computer programs may be embodied as source code and undergo compilation for implementation on processing devices or a system of devices, or may be embodied as object code, for example. They may be stored in rewriteable accessible memory media, or hard coded as embedded systems in one or more integrated circuit chips. Those of ordinary skill will readily understand that the term computer in its most general sense encompasses programmable devices such as those referred to above, and data processing apparatus, computer systems and the like. Preferably, the computer programs are stored on carrier media in machine or device readable form, for example in solid-state, optical or magnetic memory, and processing devices utilize the programs or parts thereof to configure themselves for operation.

It should also be appreciated that the various methods according to exemplary embodiments of the present invention can be effected using a related combination of automated and manual processes. However, greater use of automated processing and a wider range of features with multiple executions and elections is contemplated. For example, it should be understood that user selection of persona elements and the validation of persona information is preferably effected electronically in a secure fashion; and the persona information is preferably stored in one or more databases associated with the validation service provider. User defined rules and account management by a user are preferably set or selected via a secure connection over the Internet using a web interface. Such information can, however, also be transmitted physically and subsequently entered into electronic, magnetic, optical or other non-volatile storage.

It should further be appreciated that the aspects, features and advantages made apparent from the foregoing and the drawings are efficiently attained and, since certain changes may be made in the disclosed embodiments of the inventive system and method without departing from the spirit and scope of the invention, it is intended that all matter contained herein and in the accompanying drawings shall be interpreted as illustrative and not in a limiting sense.

What is claimed:

1. A computerized method of providing online persona validation, comprising:
collecting attribute data and preferences from a user;
validating the attribute data collected from the user;
customizing the user's browsing experience and capturing data regarding the user's online activity; and
generating micro-targeted advertising to the user based upon the validated data and the captured user's on-line activity data.

2. The method of claim 1, wherein the personal attribute data comprises name, age and address.

3. The method of claim 2, wherein the personal attribute data further comprises at least one of gender, martial status and income.

4. The method of claim 1, wherein the personal attribute data further comprises at least one of gender, martial status, income, criminal record, credit data, education level and complete employment history.

5. The method of claim 1, wherein the data collected form the user is validated through at least one of user-provided documents, interfaces with public records and interfaces with third-party data sources.

6. The method of claim 1, wherein the user browsing experience is customized and the user traffic data are captured via a plug-in to the user's Internet browser.

7. The method of claim 1, wherein the captured on-line user data comprises at least one of preferences, online shopping history, time spent at each URL, click throughs to links, and other online behavior.

8. The method of claim 1, wherein the personal attribute data is stored in a primary attribute table for the user.

9. The method of claim 1, wherein the captured user data is stored in a plurality of segmented attribute tables for the user.

10. The method of claim 9, wherein each of the segmented attribute tables is arranged so as to facilitate processing of the segmented attribute table by a targeted advertising process.

11. The method of claim 1, wherein the micro-targeted advertising is generated by an advertisement generation process.

12. The method of claim 1, further comprising capturing a user's off-line behavior, and generating micro-targeted advertising to the user based upon the validated data and the captured on-line and off-line user traffic data.

13. The method of claim 12, wherein said user's off-line behavior comprises at least one of purchases using credit cards, geolocational data, temporal-geolocational data and use of offer or coupon.

14. The method of claim 13, wherein said geolocational data is provided by a cellphone, smartphone or other mobile device.

15. The method of claim 13, wherein said geolocational data comprises one of co-ordinates obtained from GPS signals and co-ordinates obtained from triangulation of cellular telephone signals.

16. The method of any of claims 12-15, wherein the micro-targeted advertising is geo-targeted.

17. The method of any of claims 12-15, wherein the micro-targeted advertising is delivered to each of the user's computer, mobile device and cellular telephone.

18. The method of claim 17, wherein the micro-targeted advertising is delivered to a user via a presentation agent that resides on a user's computer, mobile device and cellular telephone.

19. The method of claim 1, wherein the micro-targeted advertising is generated by an advertising network partner.

20. The method of any of claims 12-15, wherein the micro-targeted advertising comprises offers which the user can use either on or off-line.

21. The method of claim 20, further comprising tracking the user's redemption of said offers and providing campaign analytics regarding the offer.

22. The method of claim 21, further comprising refining or modifying the advertisement or offer in response to said analytics.

23. The method of claim 21, wherein said analytics comprise at least one of response rate, mean response time, statistics regarding responses of all users, and geolocation at time of response.

24. The method of claim 1, wherein the user can see the information being collected about himself, and can edit his preferences and interests to modify his profile.

25. The method of claim 1, wherein the user can turn off the capturing of user on-line data and interact on-line in a private mode.

26. A computerized system for online persona validation, comprising:
a customer facing component, comprising:
a user accessible website;
at least one physical location; and
an online advertising and direct marketing presentation module,
a system back-end component, comprising:
a validation engine;
a system database; and
a direct marketing engine, and
a partner interface, said partner interface arranged to communicate data between:
the system validation engine and at least one data and validation partner;
the system database and at least one advertising and marketing partner; and
the at least one advertising and marketing partner and the online advertising and direct marketing presentation module.

27. The system of claim 26, wherein the customer facing component further comprises at least one key site endorser, communicably connected to the online advertising and direct marketing presentation module.

28. The system of claim 26, wherein the system website transfers user identity and persona attributes to the validation engine, and wherein the validation engine communicates with said at least one data and validation partner via the partner interface.

29. The system of claim 26, wherein the system database transfers user persona attributes to said at least one advertising and marketing partner, and wherein said at least one advertising and marketing partner generates at least one of micro-segmented online advertising and direct marketing for the user.

30. The system of claim 26, wherein in the system database the user persona attributes are stored in a primary attribute table and a plurality of micro-segmented attribute tables.

31. The system of claim 30, wherein each of said micro-segmented attribute tables is arranged to reside in near memory and to facilitate rapid data processing by an advertising generation module.

32. The system of claim 26, further comprising a system presentation agent interface, which communicates with a system presentation agent resident on the user's computer.

33. The system of claim 32, wherein the system presentation agent interface collects data regarding the user's on-line activity.

34. The system of claim 33, wherein said data regarding said user's on-line activity comprises at least one of preferences, online shopping history, time spent at each URL, click-throughs to links, and other online behavior.

35. The system of claim 26, further comprising a mobile activity interface, which acquires geolocational data regarding a user.

36. A computerized system for online persona validation and targeted marketing, comprising:
a presentation services layer, arranged to interface with a user;
an integration services layer, arranged to provide data migration and interface with external data sources and advertising networks;
a foundation services layer, arranged to provide business rules, security and data processing services to multiple system components; and
a data services layer, arranged to store all system data.

37. The system of claim 36, wherein the data services layer comprises a data warehouse and at least one operational data marts, wherein the data warehouse stores detailed data regarding users, and each operational data mart stores a small slice of said detailed data.

38. The system of claim 37, wherein each of said operational data marts are arranged so as enable quick access to specific attributes of a user's profile so that at least one of advertising networks and the system can take action based on said user profile and real-time input.

39. The system of claim 38, wherein said real-time input includes at least one of time of day, location, and user's browsing activity.
